(19) United States
(12) Patent Application Publication
(10) Pub. No.: US 2026/0169671 A1
(43) Pub. Date: Jun. 18, 2026

(54) ELECTRONIC DEVICE, DISPLAY DEVICE, AND OPERATING METHODS THEREOF

(71) Applicant: Samsung Electronics Co., Ltd., Suwon-si (KR)

(72) Inventor: Daehyung LEE, Suwon-si (KR)

(21) Appl. No.: 19/445,038

(22) Filed: Jan. 9, 2026

Related U.S. Application Data
(63) Continuation of application No. PCT/KR2025/021137, filed on Dec. 9, 2025.

(30) Foreign Application Priority Data
Dec. 12, 2024 (KR) 10-2024-0185081

(51) Int. Cl. G06F 3/14

(52) U.S. Cl. CPC G06F 3/1446

(57) ABSTRACT

An electronic device may generate an image frame including image data, a command for requesting state data for each of a plurality of display devices included in a multi-display, and a data space for writing the state data for each of the plurality of display devices. The electronic device may transmit the image frame to the multi-display. The electronic device may receive, from the multi-display, the image frame including the state data obtained from each of the plurality of display devices while the image frame is being transmitted from a first display device to an N^{th} display device which are included in the plurality of display devices.

### CROSS-REFERENCE TO RELATED APPLICATIONS

This application is a continuation of International Application No. PCT/KR2025/021137 designating the United States, filed on Dec. 9, 2025, in the Korean Intellectual Property Receiving Office and claiming priority to Korean Patent Application No. 10-2024-0185081, filed on Dec. 12, 2024, in the Korean Intellectual Property Office, the disclosures of each of which are incorporated by reference herein in their entireties.

### BACKGROUND

### Field

The disclosure relates to an electronic device, a display device, and operating methods thereof. For example, the disclosure relates to an electronic device for performing a diagnosis on all of a plurality of display devices using an image frame in a multi-display system, and an operating method of the electronic device.

### Description of Related Art

Various electronic devices, such as display devices, have been developed into forms to increase use efficiency and satisfy various demands of users, as the electronic devices have provided complex and diverse functions.

A multi-display system refers to displaying an image by arranging two or more display devices. The multi-display system enables an image to be displayed on a screen having an increased size, by displaying the image by connecting a plurality of display devices. A dual monitor may be used in a household or an office, or a multi-display system may be used for an indoor or outdoor advertisement board for commercial use. Recently, large-sized digital signage has been used at public spaces or outer walls of buildings for displaying image content, advertisement content, information, etc.

To secure the stability of use of the multi-display system, research into a method of diagnosing a plurality of display devices has been required.

### SUMMARY

According to an example embodiment of the disclosure, there is provided an electronic device. The electronic device according to an example embodiment of the disclosure may include: at least one processor including processing circuitry; memory storing one or more instructions, wherein at least one processor, individually and/or collectively, may be configured to execute the instructions and to cause the electronic device to: generate an image frame including image data, a command for requesting state data for each of a plurality of display devices included in a multi-display, and a data space for writing the state data for each of the plurality of display devices; control a communicator comprising communication circuitry to transmit the image frame to the multi-display; and receive, from the multi-display, the image frame including the state data obtained from each of the plurality of display devices while the image frame is being transmitted from a first display device to an N^{th} display device which are included in the plurality of display devices.

According to an example embodiment of the disclosure, there is provided a display device. The display device according to an example embodiment of the disclosure may include: at least one processor including processing circuitry; memory storing one or more instructions, wherein at least one processor, individually and/or collectively, may be configured to execute the instructions and to cause the display device to: receive, through a communicator comprising communication circuitry, an image frame including image data, a command for requesting state data for each of a plurality of display devices included in a multi-display, and a data space for writing the state data for each of the plurality of display devices; write, on the image frame, the state data of the display device; and transmit, through the communicator, the image frame including the state data.

According to an example embodiment of the disclosure, there is provided a method of operating an electronic device. The method of operating the electronic device may include: generating an image frame including image data, a command for requesting state data for each of a plurality of display devices included in a multi-display, and a data space for writing the state data for each of the plurality of display devices; transmitting the image frame to the multi-display; and receiving, from the multi-display, the image frame including the state data obtained from each of the plurality of display devices while the image frame is being transmitted from a first display device to an N^{th} display device which are included in the plurality of display devices.

According to an example embodiment of the disclosure, there is provided a method of operating a display device. The method of operating the display device may include: receiving an image frame including image data, a command for requesting state data for each of a plurality of display devices included in a multi-display, and a data space for writing the state data for each of the plurality of display devices; writing, on the image frame, the state data of the display device; and transmitting the image frame including the state data of the display device.

According to an example embodiment of the disclosure, there may be provided a non-transitory computer-readable recording medium having recorded thereon a program for executing, on a computer, the method of operating the electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example embodiment;

FIG. 2 is a diagram illustrating an example of a multi-display system arranged in an N×N form according to an embodiment of the disclosure;

FIG. 3 is a flowchart illustrating an example method of operating an electronic device, according to an embodiment of the disclosure;

FIG. 4 is a diagram illustrating an example of an image frame including a command for requesting state data transmitted from an electronic device, according to an embodiment of the disclosure;

FIG. 5 is a diagram illustrating an example of an image frame transmitted from a first display device to a second display device, according to an embodiment of the disclosure;

FIG. 6 is a diagram illustrating an example of an image frame transmitted from a second display device to a third display device, according to an embodiment of the disclosure;

FIG. 7 is a diagram illustrating an example of an image frame transmitted from an N^{th} display device to an electronic device, according to an embodiment of the disclosure

FIG. 8 is a flowchart illustrating an example method of operating a display device, according to an embodiment of the disclosure;

FIG. 9 is a signal flow diagram illustrating example operations of an electronic device and first to third display devices, according to an embodiment of the disclosure;

FIG. 10 is a flowchart illustrating example operations in which an electronic device transmits an image frame including control data, according to an embodiment of the disclosure;

FIG. 11 is a diagram illustrating an example of an image frame including control data, according to an embodiment of the disclosure;

FIG. 12 is a flowchart illustrating example operations in which a display device performs an operation based on control data, according to an embodiment of the disclosure;

FIG. 13 is a signal flow diagram illustrating example operations of an electronic device and first to third display devices, according to an embodiment of the disclosure;

FIG. 14 is a block diagram illustrating an example configuration of an electronic device according to an embodiment of the disclosure;

FIG. 15 is a block diagram illustrating an example configuration of a system including an electronic device and a first display device, according to an embodiment of the disclosure.

### DETAILED DESCRIPTION

Hereinafter, various example embodiments of the disclosure will be described in greater detail with reference to the accompanying drawings. However, the disclosure may have different forms and should not be construed as being limited to the various example embodiments of the disclosure described herein. In the drawings, parts not related to descriptions may be omitted for the clear description of the disclosure, and throughout the disclosure, like reference numerals are used for like elements.

The terms used in the disclosure are common terms that are currently widely used, in consideration of their function in the disclosure. However, the terms may become different according to an intention of one of ordinary skill in the art, a precedent, or the advent of new technology. Therefore, the terms used in the disclosure should not be interpreted merely by the terms, but should be interpreted based on the meaning of the terms and the content throughout the disclosure.

Terms such as “the first,” “the second,” etc. may be used to describe various components, but the components are not limited by these terms. The terms are used for distinguishing one component from another component.

The terms used in the disclosure are merely used to describe example embodiments of the disclosure and are not aimed to limit the disclosure. Unless a singular meaning is apparent contextually, a singular expression may include a plural meaning. In addition, throughout the disclosure, when a part is referred to as being “connected” to other parts, the part may be “directly connected” to the other parts or may be “electrically connected” to the other parts with other devices therebetween. When a part “includes” a certain element, unless it is specifically mentioned otherwise, the part may further include another component and may not exclude the other component.

The expression such as “the” and other similar referring expressions used in this disclosure, particularly, the claims, may refer to both singular and plural elements. Unless orders of operations for describing a method according to the disclosure are clearly described, the operations may be performed in appropriate orders. The disclosure is not limited to the described orders of the operations.

The expression “in some embodiments of the disclosure” or “according to an embodiment of the disclosure” described in various parts of this disclosure does not necessarily refer to the same embodiment of the disclosure.

One or more example embodiments of the disclosure may be described as functional block components and various processing operations. Part or all of such functional blocks may be realized by various numbers of hardware and/or software components configured to perform specified functions. For example, the functional blocks of the disclosure may be implemented by one or more micro-processors or by circuit structures for certain functions. For example, the functional blocks of the disclosure may be implemented by various programming or scripting languages. The functional blocks may be realized by algorithms executed by one or more processors. The disclosure could employ conventional techniques for electronics configuration, signal processing and/or data control. The words, such as “mechanism,” “element,” “device,” and “component,” may be used broadly and are not limited to mechanical and physical components.

Connection lines or connection members between components illustrated in the drawings are intended to represent example functional connections and/or physical or logical connections between the components. It should be noted that many alternative or additional functional connections, physical connections or logical connections may be present in a practical device.

Functions or operations described in the disclosure may be individually processed by one processor and/or collectively processed by a plurality of processors. The one processor or the combination of the plurality of processors may refer to circuitry and may include the circuitry, such as an application processor (AP) a communication processor (CP), a graphical processing unit (GPU), a neural processing unit (NPU), a microprocessor unit (MPU), a system on chip (SoC), an integrated chip (IC), etc.

Combinations of blocks in flowcharts illustrated in the disclosure and the flowcharts shall be understood to be performed by one or more computer programs including computer-executable instructions. The one or more computer programs may be stored in a single memory or may be separately stored in a plurality of different memories.

In the disclosure, “state data” may indicate data including state information of a display device. The state data according to an embodiment of the disclosure may include temperature information, humidity information, coordinate information, brightness information, color temperature information, version information, etc. of a display device.

In the disclosure, “a command for requesting state data” may indicate information about a collection command for state data for collecting the state data from a display device. The command for requesting the state data according to an embodiment of the disclosure may include identification (ID) information of the display device and information about a type of the state data to be collected.

In the disclosure, “control data” may indicate data including control information instructing the display device to perform operations. The control data according to an embodiment of the disclosure may include ID information of the display device and the control information. The control information according to an embodiment of the disclosure may include coordinate setting information, brightness setting information, resolution setting information, color temperature setting information, version update information, etc.

Hereinafter, various example embodiments of the disclosure will be described in greater detail with reference to the accompanying drawings. However, the disclosure may have different forms and should not be construed as being limited to the various example embodiments of the disclosure described herein.

Hereinafter, the disclosure is described in greater detail with reference to the accompanying drawings.

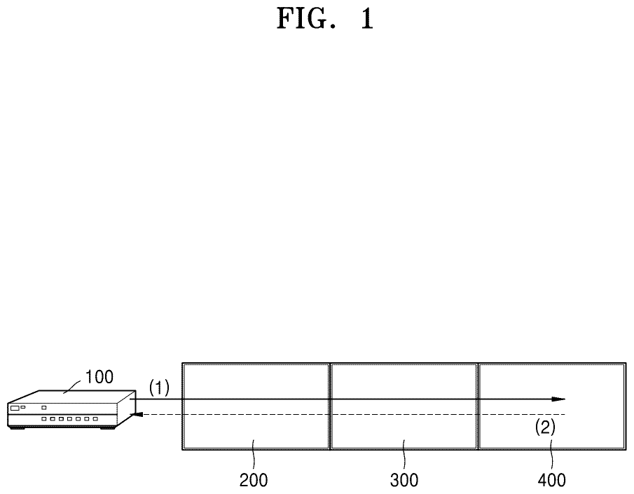

FIG. 1 is a diagram illustrating an example embodiment of the disclosure.

FIG. 1 illustrates a multi-display system in which an electronic device 100 operates with a plurality of display devices, for example, first to third display devices 200, 300, and 400, according to an embodiment of the disclosure.

Referring to FIG. 1, the electronic device 100 according to an embodiment of the disclosure may provide content, such as video, audio, etc., to the first display device 200, the second display device 300, and the third display device 300. The electronic device 100 may include various types of electronic devices which may provide content to the first display device 200, the second display device 200, and the third display device 300, such as, for example, and without limitation, a set top box, a digital versatile disc (DVD) player, a Blu-ray disc player, a personal computer (PC), a game machine, etc. The electronic device 100 may be referred to as a source device because the electronic device 100 provides content. In addition thereto, the electronic device 100 may also be referred to as a host device, a content providing device, a computing device, etc.

Referring to FIG. 1, the first display device 200, the second display device 300, and the third display device 400 according to an embodiment of the disclosure may display, on screens, the content received from the electronic device 100. The first display device 200, the second display device 300, and the third display device 400 may include various types of electronic devices, for example, and without limitation, a smart television (TV), a network TV, an Internet TV, a web TV, an Internet protocol TV (IPTV), a PC, etc., that may receive and output content. The first to third display devices 200 to 400 may be referred to as the display devices because they receive and display content. In addition thereto, the first to third display devices 200 to 400 may also be referred to as content receiving devices, sync devices, electronic devices, computing devices, etc. The electronic device 100 may be referred to as a primary device, and the first to third display devices 200 to 400 may be referred to as secondary devices.

According to an embodiment of the disclosure, through the multi-display system including the plurality of display devices, an image may be displayed on the plurality of display devices arranged in parallel, so that the image may be displayed on a screen having an increased size. The multi-display system may include various structures. For example, the multi-display system may include a structure in which the plurality of display devices may be arranged horizontally, a structure in which the plurality of display devices may be arranged vertically, or a structure in which the plurality of display devices may be arranged in an N×N form. For example, hundreds of display devices may be arranged in an N×N form at an outdoor public space or on an outer wall of a building.

Referring to FIG. 1, the first display device 200, the second display device 300, and the third display device 400 may be arranged to be adjacent to each other in a horizontal direction so that an image may be displayed on a screen having an increased size. According to an embodiment of the disclosure, the electronic device 100 may transmit an image frame for providing content to the plurality of display devices 200,300, and 400. The image frame may be transmitted in a direction (1) from the electronic device 100 to the first display device 200, the second display device 300, and the third display device 400.

The multi-display system according to an embodiment of the disclosure may be configured to diagnose a state of each of the plurality of display devices. For example, because a display device mounted outdoors may be exposed to an external environment, it may be desirable to diagnose whether appropriate temperature, humidity, etc. are maintained to drive the display device. The electronic device 100 may perform a diagnosis on a state of each of a plurality of display devices, such as a temperature, humidity, etc., when the plurality of display devices are mounted, or according to a predetermined period.

According to an embodiment of the disclosure, when the electronic device 100 transmits the image frame, the electronic device 100 may transmit the image frame by including, in a remaining data space of the image frame, except for an image data space, a command for requesting state data for a diagnosis of the display device. The electronic device 100 may include, in one or more data spaces of the image frame, a command for requesting a type of state data to be collected from each display device.

According to an embodiment of the disclosure, when the electronic device 100 transmits the image frame, the electronic device 100 may transmit the image frame by including, in the remaining data space of the image frame, except for the image data space, control data including control information instructed to be executed by each display device.

Referring to FIG. 1, the image frame transmitted from the electronic device 100 may be sequentially transmitted to the first display device 200, the second display device 300, and the third display device 400 in the direction (1), and based on the command for requesting the state data, which is included in the image frame, may request and obtain the state data from each of the first to third display devices 200 to 400. After the state data is obtained from the third display device 400, the image frame including the state data of the first to third display devices 200 to 400 may be transmitted to the electronic device 100 in a direction (2) which is a direction inverse to the transmission direction.

According to an embodiment of the disclosure, the electronic device 100 may load, in a remaining data space (for example, 74 Kbyte) in one image frame (for example, 16 msec), except for an image data space, commands for requesting state data with respect to all of a plurality of display devices (for example, 200 displays), and may sequentially transmit the commands to the plurality of display devices in a loop fashion. As the image frame is transmitted to each display device, the state data may be collected from each display device, and when the state data from a last display device is collected, an image frame on which the state data of all of the display devices is written may be transmitted to the electronic device 100 in a direction inverse to the transmission direction. Accordingly, the electronic device 100 may collect the state data for all of the display devices within a short period of time.

According to an embodiment of the disclosure, the electronic device 100 may not request one type of state data for any one display device from among the plurality of display devices by transmitting one image frame. Rather, the electronic device 100 may request and collect a type of state data or all types of state data for each of the plurality of display devices by transmitting and receiving one image frame, and thus, a diagnosis speed based on the state data for all of the plurality of display devices may be improved, and the diagnosis time may be reduced.

According to an embodiment of the disclosure, the electronic device 100 may transmit the control data for each of the plurality of display devices using one image frame, and thus, the control speed with respect to all of the plurality of display devices may be improved and the control time may be reduced.

Therefore, when the multi-display system is used, efficient diagnosis and control with respect to all of the plurality of display devices may become possible.

FIG. 1 is provided to illustrate and describe an example embodiment of the disclosure, and the disclosure is not limited thereto.

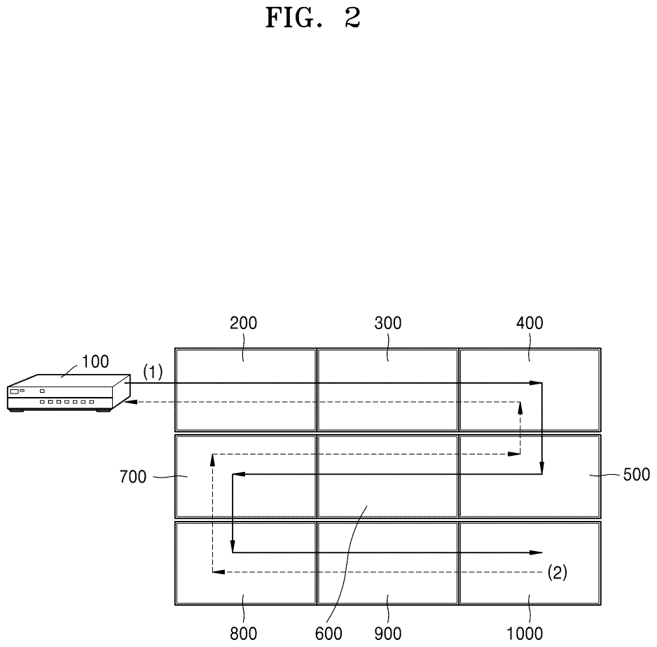

FIG. 2 is a diagram illustrating an example of a multi-display system arranged in an N×N form, according to an embodiment of the disclosure.

FIG. 2 illustrates the multi-display system in which 9 display devices, namely, first to ninth display devices 200, 300, 400, 500, 600, 700, 800, 900, and 1000, are formed in a 3×3 form, according to an example embodiment of the disclosure.

As illustrated in FIG. 2, in the multi-display system formed in the example 3×3 form, for example, an image frame transmitted from the electronic device 100 may be sequentially transmitted, in the direction (1) toward the right direction, to the first to third display devices 200 to 400 arranged horizontally in parallel, may be sequentially transmitted toward the left direction to the fourth to sixth display devices 500 to 700 in a second row, and may be sequentially transmitted toward the right direction to the seventh to ninth display devices 800 to 1000 in a third row.

After the image frame finally reaches the ninth display device 1000, which is the last display device in the transmission process, the image frame may be transmitted to the electronic device 100 in a bypass fashion in the direction (2), which is a direction inverse to the transmission direction.

According to an embodiment of the disclosure, when the electronic device 100 transmits the image frame, the electronic device 100 may transmit the image frame by including a command for requesting state data of the first to ninth display devices 200 to 1000 in a remaining data space of the image frame excluding an image data space.

Referring to FIG. 2, the image frame transmitted from the electronic device 100 may be sequentially transmitted in the direction (1) to the first display device 200, the second display device 300, the third display device 400, the fourth display device 500, the fifth display device 600, the sixth display device 700, the seventh display device 800, the eighth display device 900, and the ninth display device 1000, and based on the command for requesting the state data included in the image frame, may request and obtain the state data from each of the first to ninth display devices 200 to 1000. After obtaining of the state data from the ninth display device 1000 is completed, the image frame on which the state data of the first to ninth display devices 200 to 1000 is written may be transmitted to the electronic device 100 in the direction (2), which is the direction inverse to the transmission direction.

According to an embodiment of the disclosure, when the electronic device 100 transmits the image frame, the electronic device 100 may transmit the image frame by including control data including control information of the first to ninth display devices 200 to 1000 in a remaining data space of the image frame excluding the image data space.

FIG. 2 is provided to describe and illustrate an example embodiment of the disclosure, and the disclosure is not limited thereto.

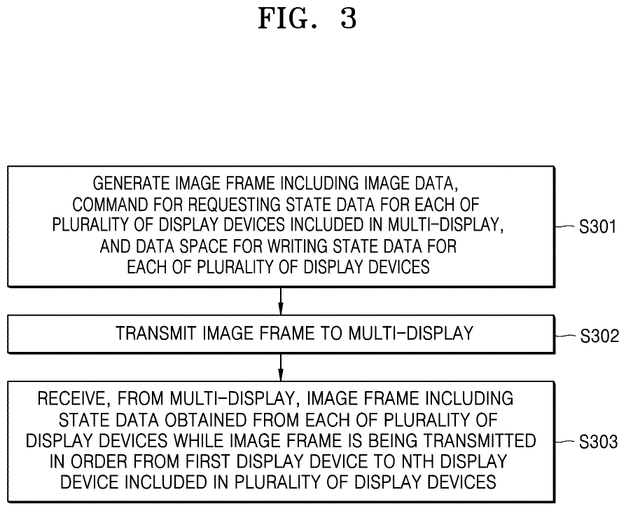

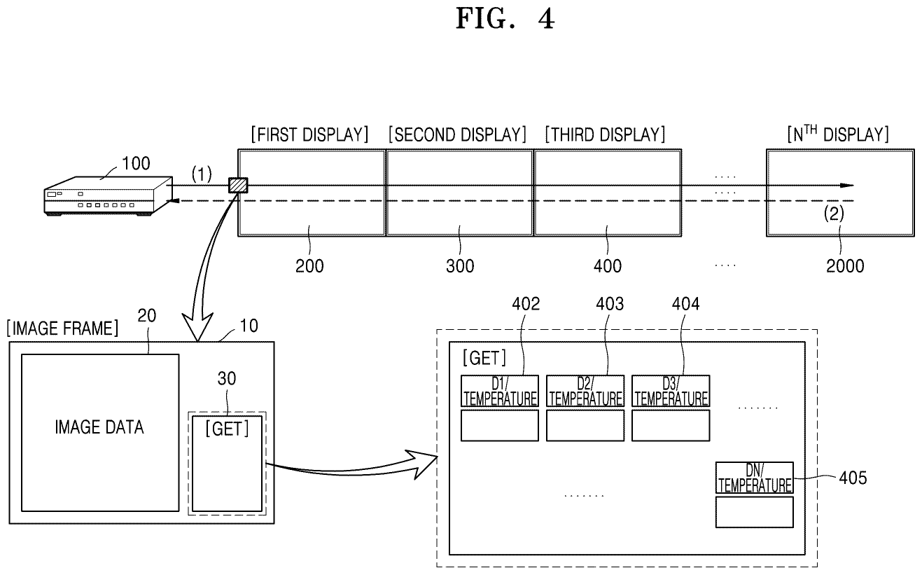

FIG. 3 is a flowchart illustrating an example method of operating an electronic device, according to an embodiment of the disclosure. While describing the flowchart of FIG. 3, FIGS. 4 to 7 may be referred to.

When the electronic device 100 according to an embodiment of the disclosure transmits an image frame including image data to be displayed, in a split fashion, on a plurality of display devices included in a multi-display, the electronic device 100 may transmit the image frame by including, in a remaining data space of the image frame, except for an image data space, a command for requesting state data of each of the plurality of display devices, and may receive an image frame on which the state data collected from each display device is written.

In operation S301 of FIG. 3, the electronic device 100 may generate the image frame including the image data, the command for requesting the state data for each of the plurality of display devices included in the multi-display, and a data space for writing the state data of each of the plurality of display devices.

According to an embodiment of the disclosure, the command for requesting the state data may indicate information about an instruction for collecting state data for collecting the state data from the display device. The command for requesting the state data may include ID information of a display device from which the state data is to be collected and information about a type of the state data to be collected.

The state data according to an embodiment of the disclosure may include temperature information, humidity information, coordinate information, brightness information, color temperature information, version information, etc. of the display device.

The information about the type of the state data included in the command for requesting the state data according to an embodiment of the disclosure may include at least one of temperature information, humidity information, coordinate information, brightness information, color temperature information, or version information of the display device. Also, the information about the type of the state data included in the command for requesting the state data may be set as all types which may be requested.

FIG. 4 is a diagram illustrating an example of an image frame including a command for requesting state data, transmitted from an electronic device, according to an embodiment of the disclosure.

Referring to FIG. 4, an image frame 10 may include, in addition to a space of image data 20, a command 30 for requesting state data of first to N^{th} display devices 200 to 2000 and a data space for writing the state data for each of the plurality of display devices.

For example, a command 402 for requesting first state data may include ID information D1 of a display device (the first display device 200) from which the state data is to be collected and information about a type (temperature) of the state data to be collected. A command 403 for requesting second state data may include ID information D2 of a display device (the second display device 300) from which the state data is to be collected and information about a type (temperature) of the state data to be collected. A command 404 for requesting third state data may include ID information D3 of a display device (the third display device 400) from which the state data is to be collected and information about a type (temperature) of the state data to be collected. Also, a command 405 for requesting N^{th} state data may include ID information DN of a display device (the N^{th} display device 2000) from which the state data is to be collected and information about a type (temperature) of the state data to be collected.

According to an embodiment of the disclosure, the electronic device 100 may transmit, to a multi-display, the image frame 10 including the image data 20 and the command 30 for requesting the state data for each of a plurality of display devices including the first to N^{th} display devices, in the direction (1) (FIG. 4).

In operation S302 of FIG. 3, the electronic device 100 may transmit the image frame to the multi-display.

According to an embodiment of the disclosure, the image frame including the command for requesting the state data for each of the plurality of display devices may be sequentially transmitted from the first display device to the second display device arranged to be adjacent thereto, from the second display device to the third display device, and finally to the N^{th} display device which is the last display device.

According to an embodiment of the disclosure, the image frame may include address information to which the image frame is to be transmitted. For example, the image frame may include the address information to be sequentially transmitted to the adjacent display devices from the first display device to the N^{th} display device.

According to an embodiment of the disclosure, the display device receiving the image frame may write, based on the ID information of the display device and the information about the type of the state data to be collected that are included in the command for requesting the state data, the state data on the image frame, according to the information about the type of the state data requested therefrom.

Referring to FIG. 4, the first display device 200 may receive the image frame 10 including the command 402 for requesting the first state data of the first display device.

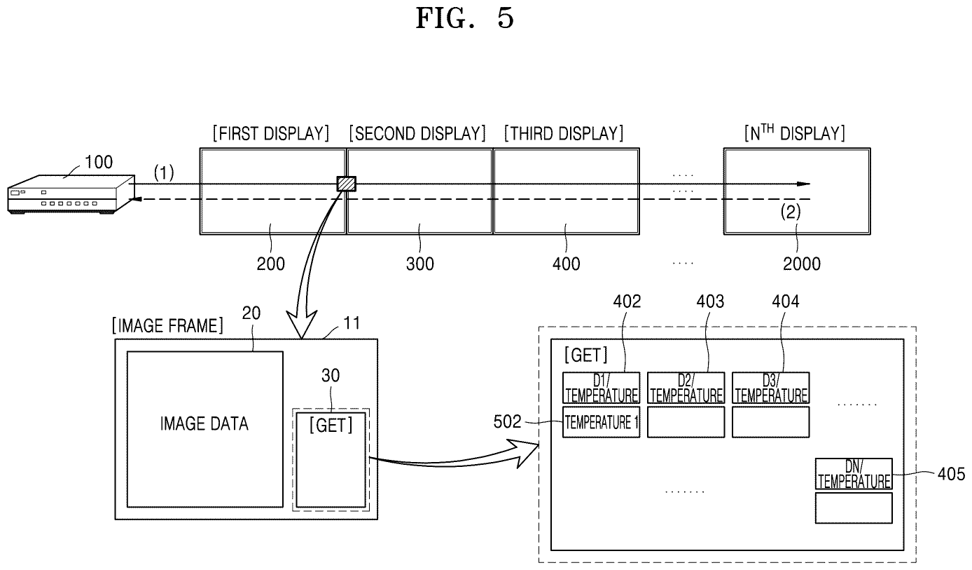

FIG. 5 is a diagram illustrating an example of an image frame transmitted from the first display 200 device to the second display device 300, according to an embodiment of the disclosure.

Referring to FIG. 5, based on the command 402 for requesting the first state data of the first display device, the first display device 200 may write, on the image frame, state data 502 including temperature information Temperature 1 of the first display device, according to the information about the type (temperature) of the state data included in the command 402 for requesting the first state data.

The first display device 200 may transmit an image frame 11 on which the state data 502 of the first display device is written to the second display device 300.

Referring to FIG. 5, the second display device 300 may receive the image frame 11 including the command 403 for requesting the second state data of the second display device 300.

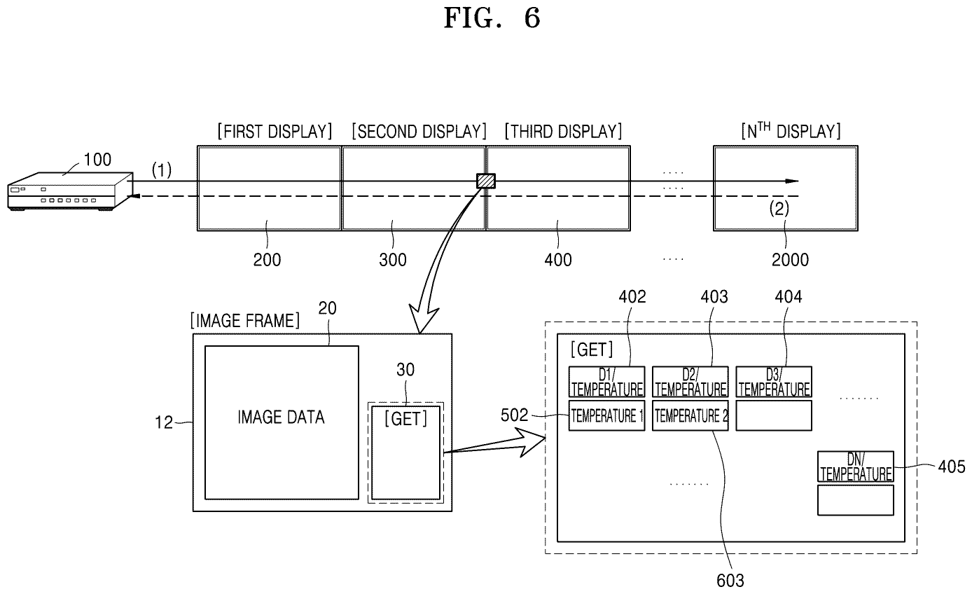

FIG. 6 is a diagram illustrating an example of an image frame transmitted from the second display device 300 to the third display device 400, according to an embodiment of the disclosure.

Referring to FIG. 6, based on the command 403 for requesting the second state data of the second display device, the second display device 300 may write, on an image frame 12, state data 603 including temperature information Temperature 2 of the second display device, according to the information about the type (temperature) of the state data included in the command 403 for requesting the second state data. The second display device 300 may transmit, to the third display device 400, the image frame 12 on which the state data 603 of the second display device is written.

The image frame 12 received by the third display device 400 may include the command 404 for requesting the third state data of the third display device 400.

The third display device 400 may write the state data (the temperature information) of the third display 400 device on the image frame, according to the information about the type (the temperature) of the state data included in the command 404 for requesting the third state data of the third display device 400.

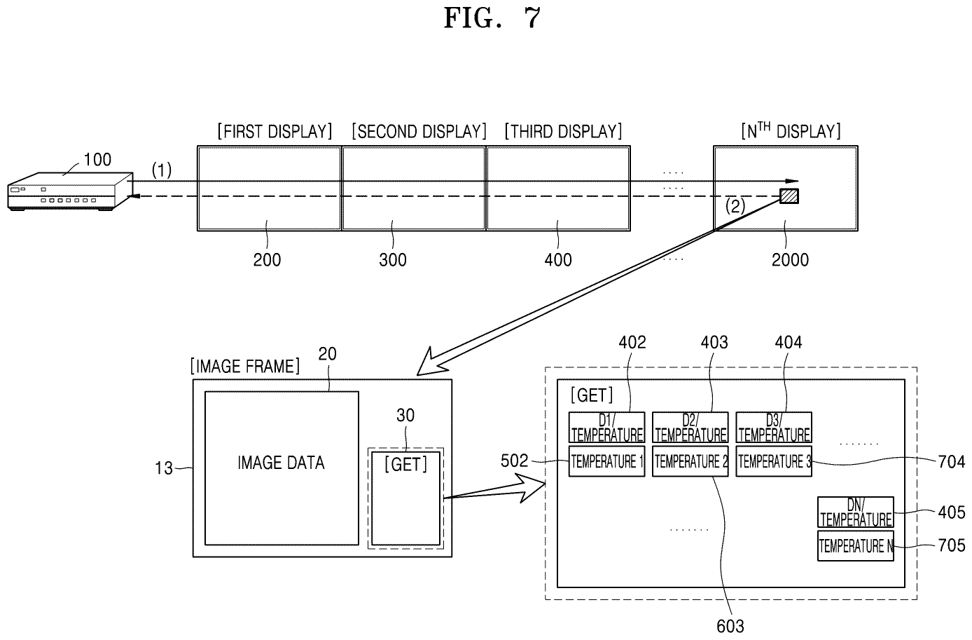

Referring to FIG. 7, an image frame 13 sequentially transmitted from the third display device 400 to the N^{th} display device 2000 in the direction (1) may include state data 704 including temperature information Temperature 3 of the third display device.

In operation S303 of FIG. 3, while the image frame is being transmitted in an order from the first display device to the N^{th} display device included in the plurality of display devices, the electronic device 100 may receive, from the multi-display, the image frame including the state data obtained from each of the plurality of display devices.

The electronic device 100 may receive the image frame in a direction inverse to the sequential transmission direction from the first display device 200 to the N^{th} display device 2000.

FIG. 7 is a diagram illustrating an example of an image frame transmitted from the N^{th} display device to the electronic device, according to an embodiment of the disclosure.

According to an embodiment of the disclosure, the N^{th} display device 2000, which is arranged to be the last of the plurality of display devices, may receive an image frame including the command 405 for requesting the N^{th} state data of the N^{th} display device. The N^{th} display device 2000 may write, on the image frame, state data 705 including temperature information Temperature N of the N^{th} display device, according to the information about the type (temperature) of the state data included in the command 405 for requesting the N^{th} state data.

The N^{th} display device 2000 may transmit the final image frame 13 on which the state data 705 of the N^{th} display device is written to the electronic device 100 in the direction (2).

According to an embodiment of the disclosure, the image frame may include address information to which the image frame is to be transmitted. For example, the image frame may include the address information to be transmitted to the electronic device 100 in a direction inverse to the transmission direction after being sequentially transmitted to the adjacent display devices from the first display device to the N^{th} display device.

According to an embodiment of the disclosure, the final image frame 13 may include the state data of all of the first display device 200 to the N^{th} display device 2000.

The electronic device 100 may obtain the state data of the plurality of display devices, included in the final image frame 13. The electronic device 100 may obtain the state data of the plurality of display devices by transmitting and receiving one image frame and may thus diagnose the plurality of display devices within a short period of time by a high speed.

According to an embodiment of the disclosure, the electronic 100 may diagnose the obtained state data of the plurality of display devices, using a predetermined (e.g., specified) state diagnosis program. The electronic device 100 may use the predetermined state diagnosis program stored in an external device (not shown), through the communicator 110. The electronic device 100 may use the predetermined state diagnosis program stored in the memory 130 of the electronic device 100.

For example, the electronic device 100 may obtain coordinate information as the state data of the display device and may diagnose whether or not it is needed to change the setting of coordinates. The electronic device 100 may obtain temperature information as the state data of the display device and may diagnose whether or not it is needed to cool the display device.

According to an embodiment of the disclosure, the image frame may include a command for requesting state data of at least one display device from among the first display device 200 to the N^{th} display device 2000. When the image frame includes the command for requesting the state data of one or more display devices from among the first to N^{th} display devices 200 to 2000, the state data of the one or more display devices may be included in the image frame, based on ID information of the display device included in the command.

FIGS. 3 to 7 are provided to illustrate and describe an example embodiment of the disclosure, and the disclosure is not limited thereto.

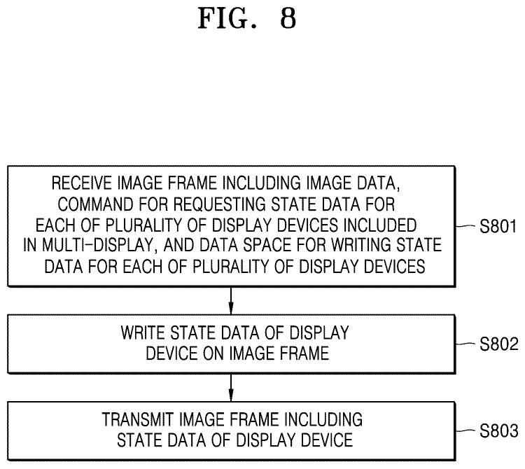

FIG. 8 is a flowchart illustrating an example method of operating a display device, according to an embodiment of the disclosure.

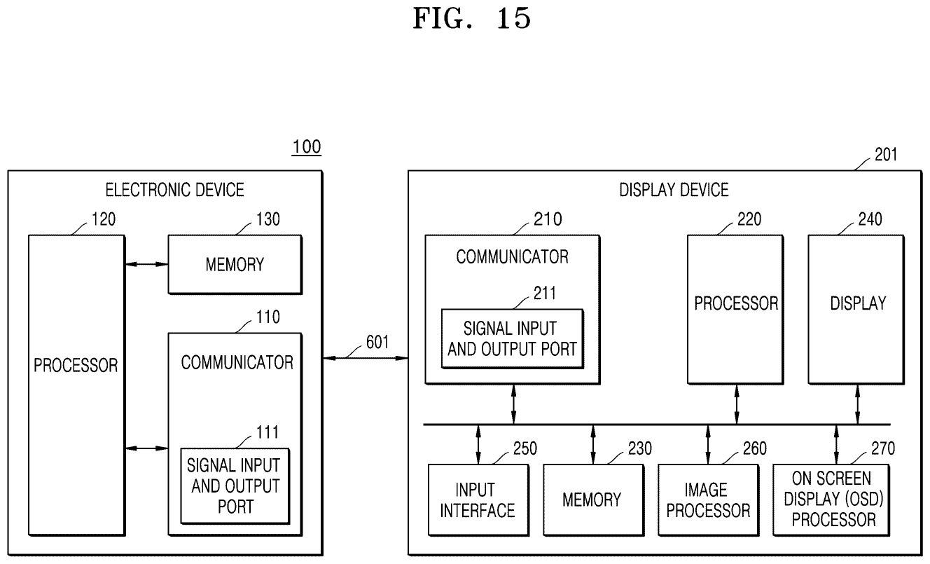

According to an embodiment of the disclosure, a display device 201 (FIG. 15) receiving an image frame including a command for requesting state data may write state data corresponding to the command on the image frame and transmit the image frame on which the state data is written to another display device arranged to be adjacent thereto.

The display device 201 according to an embodiment of the disclosure may operate as any one of a plurality of display devices and may be referred to as any one of the first to N^{th} display devices according to an arrangement order of the plurality of display devices.

In operation S801 of FIG. 8, the display device 201 may receive an image frame including image data, a command for requesting state data for each of a plurality of display devices included in a multi-display, and a data space for writing the state data for each of the plurality of display devices.

According to an embodiment of the disclosure, when the display device 201 operates as the first display device receiving the image frame from among the plurality of display devices, the display device 201 may receive, from the electronic device 100, the image frame including the command for requesting the state data including ID information and information about a type of the state data for each of the plurality of display devices.

When the display device 201 operates as the second to N^{th} display devices receiving the image frame from among the plurality of display devices, the display device 201 may receive the image frame including the command for requesting the state data respectively from the first to N−1^{th} display devices arranged to be adjacent thereto.

In operation S802 of FIG. 8, the display device 201 may write the state data of the display device 201 on the image frame.

According to an embodiment of the disclosure, the display device 201 receiving the image frame may write, based on the command for requesting the state data that corresponds to the ID information thereof, the state data corresponding to the information about the type of the state data, on a data space for writing the state data in the image frame. For example, when the information about the type of the state data included in the command is humidity information, the display device 201 may write the humidity information of the display device 201 on the image frame.

In operation S803 of FIG. 8, the display device 201 may transmit the image frame including the state data of the display device.

According to an embodiment of the disclosure, the display device 201 may transmit the image frame including the state data of the display device to another display device arranged to be adjacent thereto, based on address information included in the image frame.

When the display device 201 operates as the first to N−1^{th} display devices receiving the image frame, from among the plurality of display devices, the display device 201 may write the state data on the image frame, based on the command for requesting the state data, and then, may transmit the image frame including the command for requesting the state data to another display device arranged to be adjacent thereto.

The display device 201 receiving the image frame may transmit the image frame to the display device arranged to be adjacent thereto, based on the address information included in the image frame, so that the image frame may be sequentially transmitted from the first display device to the N^{th} display device, which is the last display device of the plurality of display devices.

According to an embodiment of the disclosure, the display device 201 may transmit the image frame including the state data to the electronic device 100 requesting the image frame, based on the address information included in the image frame. The display device 201 may transmit the image frame in a direction inverse to the sequential transmission direction from the first display device to the N^{th} display device.

When the display device 201 operates as the N^{th} display device, which is the last display device receiving the image frame from among the plurality of display devices, the display device 201 may write the state data on the image frame, based on the command for requesting the state data, and then, may transmit the image frame to the electronic device 100.

According to an embodiment of the disclosure, in the process in which each display device 201 receives the image frame for outputting content, the state data may be written on the image frame and transmitted by each display device, based on the command for requesting the state data, included in one image frame, and thus, diagnosis on the multi-display by a high speed may be possible within a reduced time period.

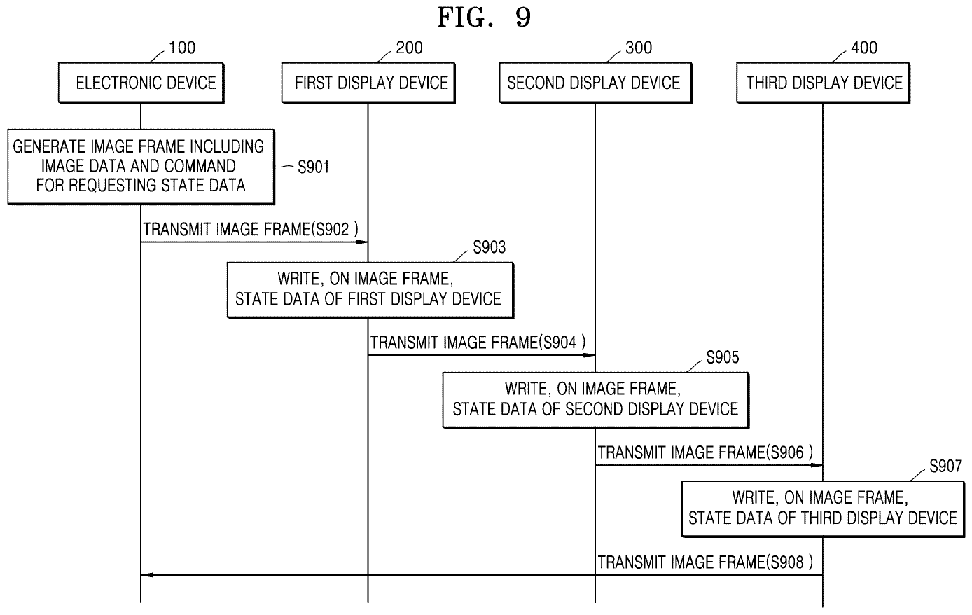

FIG. 9 is a signal flow diagram illustrating example operations of an electronic device and first to third display devices, according to an embodiment of the disclosure.

In FIG. 9, an example of a multi-display system including the electronic device 100 and the first to third display devices 200 to 400 is described.

In operation S901 of FIG. 9, the electronic device 100 may generate an image frame including image data and a command for requesting state data. The electronic device 100 may generate the image frame including the command for requesting the state data for each of the first to third display devices 200 to 400.

According to an embodiment of the disclosure, the image frame may include the command for requesting the state data of each of the first to third display devices 200 to 400. The image frame may include the command for requesting the state data of at least one of the first to third display devices 200 to 400.

In operation S902 of FIG. 9, the electronic device 100 may transmit the image frame to the first display device 200. The electronic device 100 may transmit the image frame to the first display device 200 arranged as the first display device from among the plurality of display devices, based on address information included in the image frame.

In operation S903 of FIG. 9, the first display device 200 may write the state data of the first display device 200 on the image frame. The first display device 200 may write the state data of the first display device 200 on the image frame, based on information about a type of the state data included in the command for requesting the state data.

In operation S904 of FIG. 9, the first display device 200 may transmit the image frame to the second display device 300. The first display device 200 may transmit the image frame to the second display device 300 arranged to be adjacent to the first display device 200, based on the address information included in the image frame.

In operation S905 of FIG. 9, the second display device 300 may write the state data of the second display device 300 on the image frame. The second display device 300 may write the state data of the second display device 300 on the image frame, based on the information about the type of the state data included in the command for requesting the state data.

In operation S906 of FIG. 9, the second display device 300 may transmit the image frame to the third display device 400. The second display device 300 may transmit the image frame to the third display device 400 arranged to be adjacent to the second display device 300, based on the address information included in the image frame.

In operation S907 of FIG. 9, the third display device 400 may write the state data of the third display device 400 on the image frame. The third display device 400 may write the state data of the third display device 400 on the image frame, based on the information about the type of the state data included in the command for requesting the state data.

In operation S908 of FIG. 9, the third display device 400 may transmit the image frame to the electronic device 100. According to an embodiment of the disclosure, the third display device 400 which is arranged as the last display device from among the plurality of display devices may transmit the image frame to the electronic device 100 in a direction inverse to the transmission direction in which the image frame is sequentially transmitted from the first display device 200 to the third display device 400, based on the address information included in the image frame.

The final image frame transmitted to the electronic device 100 may include the state data of all of the first to third display devices 200 to 400.

According to an embodiment of the disclosure, when the image frame includes the command for requesting the state data of one or more display devices from among the first to third display devices 200 to 400, the state data of the one or more display devices may be included in the image frame, based on ID information of the display device included in the command.

FIGS. 8 and 9 are provided to illustrate and describe an example embodiment of the disclosure, and the disclosure is not limited thereto.

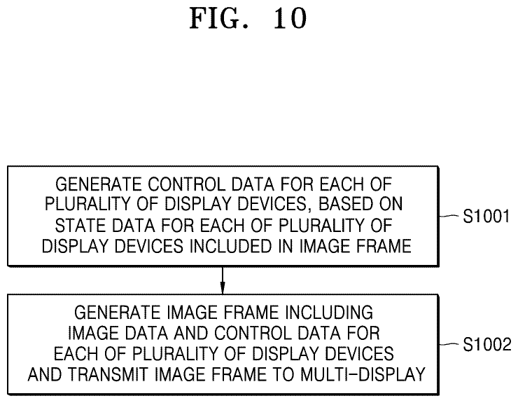

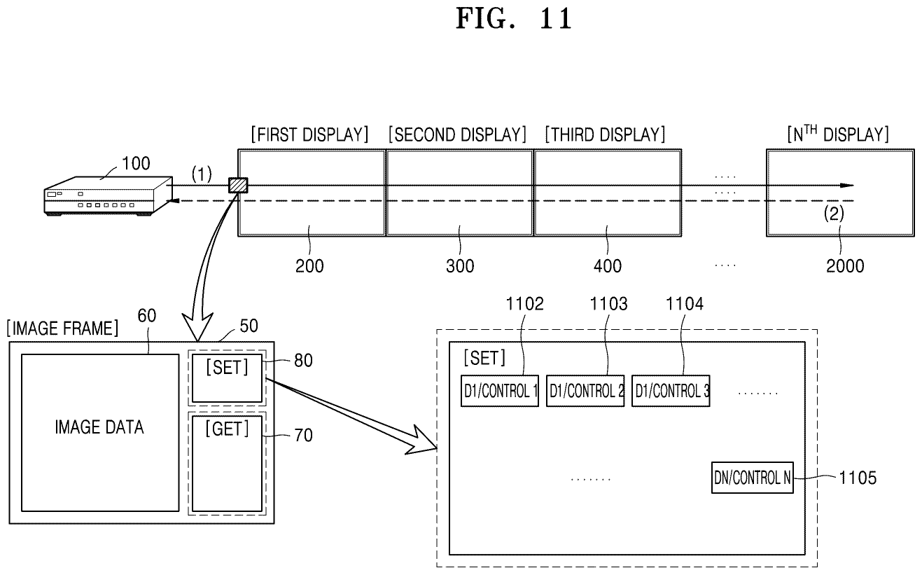

FIG. 10 is a flowchart illustrating example operations in which an electronic device transmits an image frame including control data, according to an embodiment of the disclosure. FIG. 11 is a diagram illustrating an example of the image frame including the control data, according to an embodiment of the disclosure. For describing the flowchart of FIG. 10, FIG. 11 will be referred to.

According to an embodiment of the disclosure, the electronic device 100 may control a plurality of display devices by transmitting the image frame including the control data for each of the plurality of devices. For example, the electronic device 100 may control an operation, such as changing of the setting, etc. of the display device, to be performed.

In operation S1001 of FIG. 10, the electronic device 100 may generate the control data for each of the plurality of display devices, based on the state data for each of the plurality of display devices included in the image frame.

According to an embodiment of the disclosure, the control data may include ID information of the display device and control information to be instructed to be executed by the display device. The control information according to an embodiment of the disclosure may include coordinate setting information, brightness setting information, resolution setting information, color temperature setting information, version update information, etc.

For example, the electronic device 100 may generate the control data including ID of the first display device 200 and coordinate setting information to be changed, based on coordinate information, which is the state data of the first display device 200 included in the image frame received from a multi-display.

For example, the electronic device 100 may generate the control data including ID of the second display device 300 and brightness setting information to be changed, based on brightness information, which is the state data of the second display device 300 included in the image frame received from the multi-display.

In operation S1002 of FIG. 10, the electronic device 100 may generate an image frame including image data and the control data for each of the plurality of display devices and transmit the image frame to the multi-display.

For example, the electronic device 100 may generate the image frame including, in its remaining data space excluding the image data, the control data including the ID information of the first display and the coordinate setting information, and may transmit the image frame to the multi-display.

Referring to FIG. 11, in some data spaces of an image frame 50 excluding a space of image data 60, a command 70 for requesting the state data of the first to N^{th} display devices 200 to 2000 may be included. Also, in some data spaces of the image frame 50, control data 80 of the first to N^{th} display devices 200 to 2000 may be included.

For example, first control data 1102 may include ID information D1 of the display device (the first display device 200) and control information Control 1. Second control data 1103 may include ID information D2 of the display device (the second display device 300) and control information Control 2. Third control data 1104 may include ID information D3 of the display device (the third display device 400) and control information Control 4. N^{th} control data 1105 may include ID information DN of the display device (the N^{th} display device 2000) and control information Control N.

According to an embodiment of the disclosure, the electronic device 100 may transmit the image frame 50 including the image data 60, the command 70 for requesting the state data for each of a plurality of display devices including the first to N^{th} display devices, and the control data 80, to the multi-display, in the direction (1).

FIG. 11 illustrates an example in which the image frame 50 may include the image data 60, the command 70 for requesting the state data for each of the plurality of display devices, a data space for writing the state data of each display device, and the control data 80. However, the disclosure is not limited thereto. The image frame 50 may include the image data 60 and the control data 80. The image frame 50 may include the image data 60, the command 70 for requesting the state data for each of the plurality of display devices, and the data space for writing the state data for each of the plurality of display devices.

According to an embodiment of the disclosure, the image frame may include the control data of one or more of the first to N^{th} display devices 200 to 2000. Also, according to an embodiment of the disclosure, the image frame may include the command for requesting the state data of one or more of the first to N^{th} display devices 200 to 2000.

FIGS. 10 and 11 are provided to illustrate and describe an example embodiment of the disclosure, and the disclosure is not limited thereto.

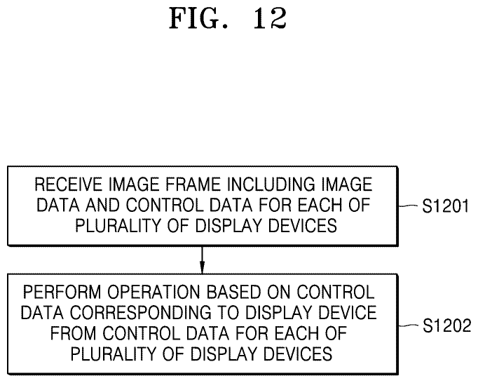

FIG. 12 is a flowchart illustrating example operations in which a display device performs an operation based on control data, according to an embodiment of the disclosure.

The display device 201 according to an embodiment of the disclosure may operate as any one of the plurality of display devices and may be referred to as any one of the first to N^{th} display devices according to the order of arrangement of the plurality of display devices.

In operation S1201 of FIG. 12, the display device 201 may receive the image frame including the image data and the control data for each of the plurality of display devices. In operation S1202, the display device 201 may perform an operation based on the control data corresponding to the display device 201 among the control data for each of the plurality of display devices.

According to an embodiment of the disclosure, the control data may include the ID information of the display device and the control information. The display device 201 may perform the operation corresponding to the control information instructing the display device to perform operations, based on the ID information of the display device. The control information according to an embodiment of the disclosure may include coordinate setting information, brightness setting information, resolution setting information, color temperature setting information, version update information, etc.

According to an embodiment of the disclosure, the electronic device 100 may generate the control data for controlling at least one display device from among the plurality of display devices, when the multi-display is initially mounted, according to a predetermined period, or when control is required based on the state data of the display device.

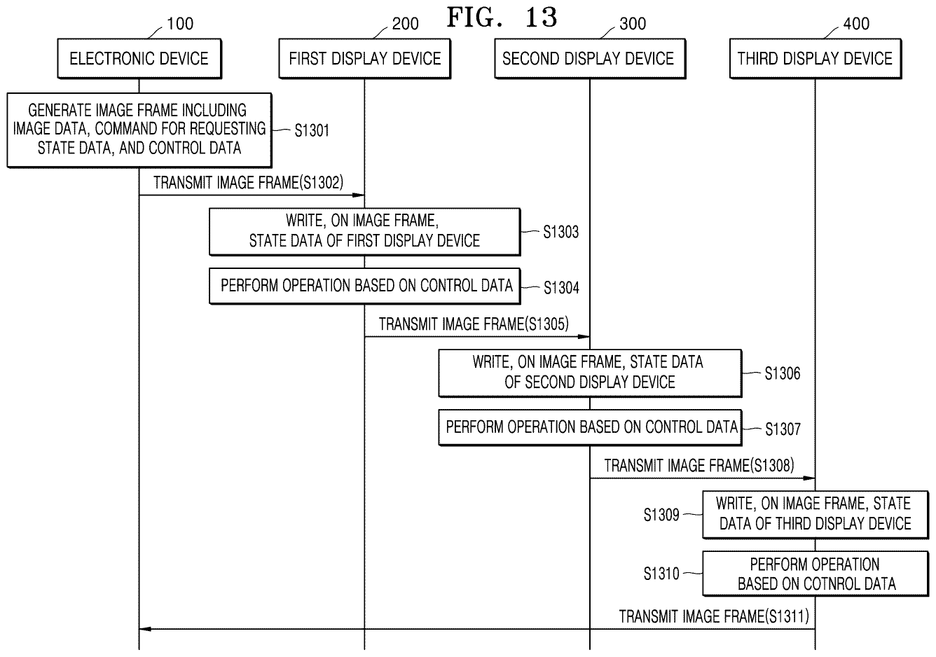

FIG. 13 is a flowchart illustrating example operations of an electronic device and first to third display devices, according to an embodiment of the disclosure.

In FIG. 13, an example of a multi-display system including the electronic device 100 and the first to third display devices 200 to 400 is described.

In operation 1301 of FIG. 13, the electronic device 100 may generate an image frame including image data, a command for requesting state data, and control data.

According to an embodiment of the disclosure, the image frame may include the control data of all of the first to third display devices 200 to 400. The image frame may include the control data of at least one of the first display device 200, the second display device 300, or the third display device 400.

The image frame may include the command for requesting the state data of all of the first to third display devices 200 to 400. Also, the image frame may include the command for requesting the state data of at least one of the first display device 200, the second display device 300, or the third display device 400.

In operation S1302 of FIG. 13, the electronic device 100 may transmit the image frame to the first display device 200. The electronic device 100 may transmit the image frame to the first display device 200 arranged as the first display device from among the plurality of display devices, based on address information included in the image frame.

In operation S1303 of FIG. 13, the first display device 200 may write the state data of the first display device 200 on the image frame. The first display device 200 may write the state data of the first display device 200 on the image frame, based on information about a type of the state data included in the command for requesting the state data.

In operation S1304 of FIG. 13, the first display device 200 may perform an operation based on the control data. The first display device 200 may perform an operation based on control information included in the control data of the first display device 200.

In operation S1305 of FIG. 13, the first display device 200 may transmit the image frame to the second display device 300. The first display device 200 may transmit the image frame to the second display device 300 arranged to be adjacent to the first display device 200, based on the address information included in the image frame.

In operation S1306 of FIG. 13, the second display device 300 may write the state data of the second display device 300 on the image frame. The second display device 300 may write the state data of the second display device on the image frame, based on the information about the type of the state data included in the command for requesting the state data.

In operation S1307 of FIG. 13, the second display device 300 may perform an operation based on the control data. The second display device 300 may perform an operation based on control information included in the control data of the second display device 300.

In operation S1308 of FIG. 13, the second display device 300 may transmit the image frame to the third display device 400. The second display device 300 may transmit the image frame to the third display device 400 arranged to be adjacent to the second display device 300, based on the address information included in the image frame.

In operation S1309 of FIG. 13, the third display device 400 may write the state data of the third display device 400 on the image frame. The third display device 400 may write the state data of the third display device 400 on the image frame, based on the information about the type of the state data included in the command for requesting the state data.

In operation S1310 of FIG. 13, the third display device 400 may perform an operation based on the control data. The third display device 400 may perform an operation based on control information included in the control data of the third display device 400.

In operation S1311 of FIG. 13, the third display device 400 may transmit the image frame to the electronic device 100. According to an embodiment of the disclosure, the third display device 400 which is arranged as the last display device from among the plurality of display devices may transmit the image frame to the electronic device 100 in a direction inverse to the transmission direction in which the image frame is sequentially transmitted from the first display device 200 to the third display device 400, based on the address information included in the image frame. The image frame transmitted to the electronic device 100 may include the state data of all of the first to third display devices 200 to 400.

According to an embodiment of the disclosure, when the image frame includes the command for requesting the state data of one or more display devices from among the first to third display devices 200 to 400, the state data of the one or more display devices may be included in the image frame, based on ID information of the display device included in the command.

According to an embodiment of the disclosure, when the image frame includes the control data of one or more of the first to third display devices 200 to 400, the operation based on the control data may be performed by the one or more display devices, based on the ID information of the display device included in the control data.

FIGS. 12 and 13 are provided to illustrate and describe an example embodiment of the disclosure, and the disclosure is not limited thereto.

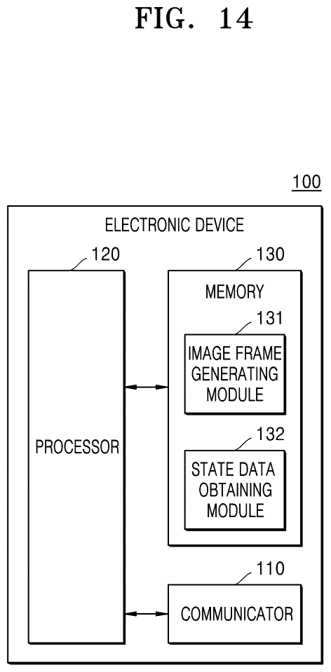

FIG. 14 is a block diagram illustrating an example configuration of an electronic device according to an embodiment of the disclosure.

Referring to FIG. 14, the electronic device 100 according to an embodiment of the disclosure may include a communicator (e.g., including communication circuitry) 110, memory 130, and a processor (e.g., including processing circuitry) 120. The processor 120 of the electronic device 100 may execute programs stored in the memory 130 to generally control the communicator 110, etc. The components of the electronic device 100 are not limited to the components illustrated in FIG. 14.

The memory 130 according to an embodiment of the disclosure may store a program to be executed by the processor 120 and may store data input to the electronic device 100 or output from the electronic device 100.

The memory 130 may include a storage medium of at least one of a flash memory-type, a hard disk-type, a multimedia card micro-type, a card-type memory (for example, SD or XD memory), random-access memory (RAM), static RAM (SRAM), read-only memory (ROM), electrically erasable programmable ROM (EEPROM), programmable ROM (PROM), a magnetic memory, a magnetic disk, or an optical disk.

Programs stored in the memory 130 may be classified into a plurality of software modules according to their functions. For example, the memory 130 may include an image frame generating module (e.g., including executable program instructions) 131 and a state data obtaining module (e.g., including executable program instructions) 132, but is not limited thereto, and the memory 130 may store at least one thereof or may further include other software modules.

According to an embodiment of the disclosure, the image frame generating module 131 may include instructions or program codes for executing a function and/or operation of generating an image frame. According to an embodiment of the disclosure, the processor 120 may execute the program codes or instructions of the image frame generating module 131 stored in the memory 130, to generate the image frame including image data, a command for requesting state data for each of a plurality of display devices included in a multi-display, and a data space for writing the state data for each of the plurality of display devices.

The processor 120 may include various processing circuitry and execute the program codes or instructions of the image frame generating module 131 stored in the memory 130 to generate control data. The processor 120 may execute the program codes or instructions of the image frame generating module 131 stored in the memory 130 to generate the image frame including the image data and the control data for each of the plurality of display devices.

The processor 120 may execute the program codes or instructions of the image frame generating module 131 stored in the memory 130 to generate the control data for each of the plurality of display devices, based on the state data for each of the plurality of display devices included in the received image frame. The processor 120 may execute the program codes or instructions of the image frame generating module 131 stored in the memory 130 to generate the image frame including the image data and the control data for each of the plurality of display devices.

According to an embodiment of the disclosure, the state data obtaining module 132 may include instructions or program codes for executing a function and/or operation of obtaining the state data of the display device. According to an embodiment of the disclosure, the processor 120 may execute the program codes or instructions of the state data obtaining module 132 stored in the memory 130 to obtain, from the received image frame, the state data obtained from each of the plurality of display devices. According to an embodiment of the disclosure, the processor 120 may obtain the state data for each of the display devices written on the data space for writing the state data for each of the plurality of display devices in the image frame.

The processor 120 may control the overall operations of the electronic device 100. The processor 120 may execute the instructions or programs stored in the memory 130 to control operations or functions performed by the electronic device 100. For example, the processor 120 may generally control the communicator 110, etc.

According to an embodiment of the disclosure, the processor 120 may include one or more processors. The processor 120 may include, for example, hardware of at least one type from among a central processing unit (CPU), a microprocessor, a graphics processing unit (GPU), application specific integrated circuits (ASICs), digital signal processors (DSPs), digital signal processing devices (DSPDs), programmable logic devices (PLDs), a micro-controller unit (MCU), and field programmable gate arrays (FPGAs), but is not limited thereto. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment of the disclosure, the processor 120 may include an MCU and FPGAs.

According to an embodiment of the disclosure, the communicator 110 may include one or more components including various communication circuitry configured to enable communication between the electronic device 100 and an external device (not shown) or between the electronic device 100 and the display device 201.

For example, the communicator 110 may include a short-range wireless communicator and a mobile communicator.

The short-range wireless communicator may include a Bluetooth communicator, a near-field communicator (NFC/radio frequency identification (RFID)), a wireless local area network (WLAN) (or WiFi) communicator, a Zigbee communicator, an infrared data association (IrDA) communicator, a ultra wideband (UWB) communicator, an Ant+communicator, etc., but is not limited thereto.

The mobile communicator may transceive a wireless signal with at least one of a base station, an external terminal, or a server on a mobile communication network. Here, the wireless signal may include a sound call signal, a video-telephony call signal, or data of various forms according to transmission and reception of text/a multimedia message.

The communicator 110 according to an embodiment of the disclosure may include various communication circuits for performing communication with at least one external device. Here, the “communication” may denote an operation of transmitting and/or receiving data, a signal, a request, and/or a command. Hereinafter, the display device 201 is described as an example of the at least one external device.

The communicator 110 may perform wired or wireless communication with the display device 201.

For example, the communicator 110 may include at least one of a communication module, a communication circuit, a communication device, an input/output port, or an input/output plug for performing wired communication with the display device 201.

For example, the communicator 110 may include at least one port to be connected to the display device 201 using wired cables, so as to communicate with the display device 201 based on a wired communication method. For example, the communicator 110 may include at least one of a high-definition multimedia interface (HDMI) port, a component jack, a PC port, a display port, or a universal serial bus (USB) port. Accordingly, the communicator 110 may perform communication with the display device 201 connected in a wired manner through the at least one port. Here, the port may refer to a physical component to or into which a cable, a communication line, or a plug may be connected or inserted.

For example, the communicator 110 may include at least one wireless communication module, wireless communication circuit, or wireless communication device for performing wireless communication with the display device 201.

For example, the communicator 110 may include a short-range wireless communication module, for example, an infrared (IR) communication module, etc., which may receive a control command from a remote controller in a short range distance, for example, an input device. In this case, the communicator 110 may receive a control signal from the remote controller.

For example, the communicator 110 may include at least one communication module for performing communication according to the wireless communication standards, such as Bluetooth, WiFi, Bluetooth low energy (BLE), NFC/RFID, WiFi-direct, UWB, or Zigbee. Alternatively, the communicator 110 may further include a communication module for performing communication with a server configured to support remote communication according to the remote communication standards. For example, the communicator 110 may include a communication module for performing communication through a network for Internet communication. Also, the communicator 110 may include a communication module for performing communication through a communication network according to the communication standards, such as the 3^{rd} generation (3G), the 4^{th} generation (4G), the 5^{th} generation (5G), and/or the 6^{th} generation (6G).

According to an embodiment of the disclosure, the communicator 110 may transmit and receive the image frame to and from a communicator 210 (see FIG. 15) of the display device 201.

According to an embodiment of the disclosure, the communicator 110 may transmit the state data of the display device to an external server (not shown) and receive a diagnosis result using a state diagnosis program stored in the external server.

The components of the electronic device 100 described above may be differently referred to. The electronic device 100 according to the disclosure may include at least one of the components described above, may exclude one or more components, or may further include additional other components.

FIG. 14 is provided to illustrate and describe an example embodiment of the disclosure, and the disclosure is not limited thereto.

FIG. 15 is a block diagram illustrating an example configuration of a system including an electronic device and a display device, according to an embodiment of the disclosure.

Referring to FIG. 15, the electronic device 100 according to an embodiment of the disclosure may include the communicator 110, the memory 130, and the processor 120. The processor 120 of the electronic device 100 may execute programs stored in the memory 130 to generally control the communicator 110, etc. The components of the electronic device 100 are not limited to the components illustrated in FIG. 15.

According to an embodiment of the disclosure, the memory 130 may include the image frame generating module 131 and the state data obtaining module 132 as illustrated in FIG. 14. The components of the electronic device 100 are described above with reference to FIG. 14, and thus, the same descriptions are not repeated.

The processor 120 of the electronic device 100 may control processing of an image signal to be transmitted to the display device 201 and may control the processed image signal to be output through the communicator 110.

The communicator 110 may include at least one signal input and output port. Through the at least one signal input and output port, the communicator 110 may receive, from the display device 201, extended display identification data (EDID) including display characteristic information including information about the resolution, etc. which may be supported, and may output an image signal having the resolution which may be processed by the display device 201. The communicator 110 may include, for example, a signal input and output port 111.

The signal input and output port 111 of the electronic device 100 and a signal input and output port 211 of the display device 201 may be connected to each other through a cable 601. The signal input and output ports 111 and 211 may include signal input and output ports according to various forms of communication protocols. For example, the signal input and output ports may include ports according to various standards, such as an HDMI port, a display port (DP), a thunderbolt port, a mobile high-definition link (MHL), a USB port, a digital visual interface (DVI) port, etc.

The display device 201 according to an embodiment of the disclosure may be configured to display an image or data and may include a communicator (e.g., including communication circuitry) 210, a display 240, memory 230, a processor (e.g., including processing circuitry) 220, an input interface (e.g., including various circuitry) 250, an image processor (e.g., including various circuitry and/or executable program instructions) 260, and an on screen display (OSD) processor (e.g., including various circuitry and/or executable program instructions) 270.

The communicator 210 may include various communication circuits for performing communication with at least one external device. Here, the “communication” may denote an operation of transmitting and/or receiving data, a signal, a request, and/or a command. Hereinafter, the electronic device 100 is described as an example of the at least one external device.

The communicator 210 may perform wired or wireless communication with the electronic device 100.

For example, the communicator 210 may include at least one of a communication module, a communication circuit, a communication device, an input/output port, or an input/output plug for performing wired communication with the electronic device 100.

For example, the communicator 210 may include at least one port to be connected to the electronic device 100 using wired cables, so as to communicate with the electronic device 100 based on a wired communication method. For example, the communicator 210 may include at least one of an HDMI port, a component jack, a PC port, a DP, or a USB port. Accordingly, the communicator 210 may perform communication with the electronic device 100 connected in a wired manner through the at least one port. Here, the port may refer to a physical component to or into which a cable, a communication line, or a plug may be connected or inserted.

For example, the communicator 210 may include at least one wireless communication module, wireless communication circuit, or wireless communication device for performing wireless communication with the electronic device 100.

For example, the communicator 210 may include a short-range wireless communication module, for example, an IR communication module, etc., that may receive a control command from a remote controller in a short range distance, for example, an input device. In this case, the communicator 210 may receive a control signal from the remote controller.

For example, the communicator 210 may include at least one communication module for performing communication according to the wireless communication standards, such as Bluetooth, WiFi, BLE, NFC/RFID, WiFi-direct, UWB, or Zigbee. Alternatively, the communicator 210 may further include a communication module for performing communication with a server configured to support remote communication according to the remote communication standards. For example, the communicator 210 may include a communication module for performing communication through a network for Internet communication. Also, the communicator 210 may include a communication module for performing communication through a communication network according to the communication standards, such as the 3G, the 4G, the 5G, and/or the 6G.

As described above, the communicator 210 may include one or more one assistant components for assisting communication between the display device 201 and the electronic device 100. Here, the assistant components may include the communication module, the communication circuit, the communication device, the port (for inputting/outputting data), the cable port (for inputting/outputting data), the plug (for inputting/outputting data), etc., described above. For example, the one or more assistant components included in the communicator 210 may include an Ethernet communication module, a WiFi communication module, a Bluetooth communication module, an IR communication module, a USB port, a tuner (or a broadcasting receiver), an HDMI port, a DP, a DVI port, etc.

According to an embodiment of the disclosure, the communicator 210 of the display device 201 may transmit or receive the image frame to or from the communicator 110 of the electronic device 100 or a communicator of another display device.

The display 240 may output image or data processed by the display device 201.

According to an embodiment of the disclosure, the display 240 may output the image data included in the image frame. Each of the plurality of displays 240 included in a multi-display may output an area of the image data, the area being assigned to its coordinate information. Each display 240 may output the area of the image data, the area being assigned thereto, and thus, the multi-display may output an image as if the image is output on one large-sized screen.

The memory 230 may store a program for processing and controlling by the processor 220 and may store data input to the display device 201 or output from the display device 201. Also, the memory 230 may store data required for operations of the display device 201.

The memory 230 may include a storage medium of at least one of a flash memory-type, a hard disk-type, a multimedia card micro-type, a card-type memory (for example, SD or XD memory), RAM, SRAM, ROM, EEPROM, PROM, a magnetic memory, a magnetic disk, or an optical disk.

The processor 220 may include various processing circuitry and control the overall operations of the display device 201. For example, the processor 220 may execute one or more instructions stored in the memory 230 to perform functions of the display device 201 described herein.

The processor 220 may include various processing circuits and/or a plurality of processors. For example, the term “processor” used herein including the claims may include various processing circuits including at least one processor. One or more processors of the at least one processor may be configured to perform various functions described herein, individually in a distributed fashion and/or collectively. As used herein, the “processor, the “at least one processor,” and the “one or more processors” may be configured to perform various functions. However, these terms may, for example, cover a situation in which one processor may perform some functions and (an)other processor(s) may perform the rest functions and a situation in which a single processor may perform all functions, but they are not limited thereto. Also, the at least one processor may include a combination of processors configured to perform various functions from among the functions described herein in a distributed fashion. The at least one processor may be configured to execute program instructions to achieve or perform various functions.

According to an embodiment of the disclosure, the processor 220 may store one or more instructions in an internal memory provided in the processor 220 and may execute the one or more instructions stored in the internal memory provided in the processor 220 to control the execution of the operations of the display device 201. That is, the processor 220 may execute the one or more instructions or programs stored in the internal memory of the processor 220 or the memory 230, to perform a predetermined operation.

According to an embodiment of the disclosure, the processor 220 may include one or more processors. The processor 220 may include, for example, hardware of at least one type from among from among a CPU, a microprocessor, a GPU, ASICs, DSPs, DSPDs, PLDs, a an MCU, and FPGAs, but is not limited thereto.

According to an embodiment of the disclosure, the processor 220 may include FPGAs.

According to an embodiment of the disclosure, the processor 220 may execute one or more instructions stored in the memory 230 to perform the operations of the display device 201 described herein.

According to an embodiment of the disclosure, the at least one processor 220 may execute the one or more instructions stored in the memory 230 to write state data of the display device 201 on an image frame.

According to an embodiment of the disclosure, the at least one processor 220 may receive, through the communicator 210, the image frame including image data, a command for requesting state data for each of a plurality of display devices included in a multi-display, and a data space for writing the state data for each of the plurality of display devices. The processor 220 may execute the one or more instructions stored in the memory 230 to write the state data of the display device 201 on a data space for writing the state data in the image frame except for an image data space.

According to an embodiment of the disclosure, the at least one processor 220 may transmit, through the communicator 210, the image frame including the state data. The processor 220 may transmit the image frame including the state data of the display device 201 to another display device arranged to be adjacent to the display device 201, based on address information included in the image frame.

The processor 220 may transmit, to the electronic device 100 requesting the image frame, the image frame including the state data, in a direction inverse to a sequential transmission direction from a first display device to an N^{th} display device, based on the address information included in the image frame.

According to an embodiment of the disclosure, the at least one processor 220 may receive, through the communicator 210, the image frame including the image data and control data for each of the plurality of display devices. The processor 220 may execute the one or more instructions stored in the memory 230 to perform an operation based on control data corresponding to a display device from the control data for each display device.

According to an embodiment of the disclosure, the electronic device 100 and the display device 201 may be connected to each other through various types of communication interfaces or image transmission interfaces so as to transmit and receive content to and from each other. The image transmission interface may be implemented, for example, as cables, and the electronic device 100 and the display device 201 may include one or more signal input and output ports to be connected to the cables. Referring to FIG. 15, for example, the electronic device 100 and the display device 201 may be connected to each other through the cable 601. The image transmission interface may include, for example, a D-subminiature (D-SUB) interface, a DVI, an HDMI, a DP, or a type-C interface. Depending on a type of the image transmission interface, the image signal exchanged between the electronic device 100 and the display device 201 may vary. The one or more signal input and output ports may transmit or receive the image signal corresponding to the standards of the connected image transmission interface.

For example, the electronic device 100 and the display device 201 may be connected to each other through the image transmission interface implemented as an HDMI cable and may exchange an HDMI image signal with each other through an HDMI port included in each of the electronic device 100 and the display device 201. The electronic device 100 may transmit, to the display device 201, the HDMI image signal corresponding to the HDMI standards, and the display device 201 may receive, from the electronic device 100, the HDMI image signal. For example, the electronic device 100 and the display device 201 may be connected to each other through the image transmission interface implemented as a DP cable and may exchange a DP image signal with each other through a DP included in each of the electronic device 100 and the display device 201.

The display device 201 may include the input interface 250, the image processor 260, and the OSD processor 270.

The display device 201 may process and output the image signal received from the electronic device 100.

The communicator 210 may receive, from the electronic device 100, the image signal, according to a connected protocol, and output the received image signal to the image processor 260. The communicator 210 may include at least one signal input and output port. The communicator 210 may include, for example, the signal input and output port 211.

The display 240 may display an image according to the image signal received from the image processor 260 and an OSD received from the OSD processor 270.

The input interface 250 may include various circuitry and be configured to receive an input from a user. The input interface 250 may include at least one of a key pad, a dome switch, a touch panel, a jog wheel, a jog switch, or an infrared key, but is not limited thereto.

The image processor 260 may include various circuitry and/or executable program instructions and process the image signal received from the communicator 210 and output the processed image signal to the display 240, according to control by the processor 220. The image processor 260 may process image quality and scaling operations according to a type of the image signal.

The OSD processor 270 may include various circuitry and/or executable program instructions and process an execution screen for controlling the display device 201 as an OSD and output the OSD to the display 240.

According to an embodiment of the disclosure, the display device 201 may include all types of devices configured to perform functions by including a processor and memory. The display device 201 may include a stationary or portable device. For example, the display device 201 may indicate a device including a display and displaying image content, video content, game content, graphics content, etc. The display device 201 may include, for example, and without limitation, various types of electronic devices capable of receiving and outputting the content, such as televisions including a network TV, a smart TV, an Internet TV, a web TV, and an IPTV, computers including a desktop, a laptop, and a tablet, and various smart devices including a smartphone, a cellular phone, a game player, a music player, a video player, medical equipment, a home appliance, etc.

FIG. 15 is a block diagram illustrating an example display device 201 according to various embodiments. Each component of the block diagram may be combined, added, or omitted according to the specification of the display device 201 that is actually implemented. For example, two or more components may be integrated into one component, or one component may be divided into two or more components, according to necessity. A function executed in each block is to describe the disclosure, and its specific operation or device does not limit the scope of the disclosure.

FIGS. 14 and 15 are provided to illustrate and describe an example embodiment of the disclosure, and the disclosure is not limited thereto.

According to an example embodiment of the disclosure, there is provided an electronic device 100. The electronic device 100 according to an embodiment of the disclosure may include at least one processor 120 including processing circuitry. The electronic device 100 according to an embodiment of the disclosure may include a memory 130 storing one or more instructions. The one or more instructions, when executed by the at least one processor 120 individually or collectively, may cause the electronic device 100 to generate an image frame including image data, a command for requesting state data for each of a plurality of display devices included in a multi-display, and a data space for writing the state data for each of the plurality of display devices.

The electronic device 100 may control a communicator 110 to transmit the image frame to the multi-display. The electronic device 100 may control the communicator 110 to receive, from the multi-display, the image frame including the state data obtained from each of the plurality of display devices while the image frame is being transmitted from a first display device to an N^{th} display device which are included in the plurality of display devices.

According to an example embodiment of the disclosure, the one or more instructions, when executed by the at least one processor 120 individually or collectively, may cause the electronic device 100 to generate, based on the state data for each of the plurality of display devices, the state data being included in the image frame, control data for each of the plurality of display devices. The electronic device 100 may generate the image frame including the image data and the control data for each of the plurality of display devices and transmit the image frame to the multi-display.

The one or more instructions, when executed by the at least one processor 120 individually or collectively, may cause the electronic device 100 to control the communicator 110 to receive the image frame in a direction inverse to a sequential transmission direction from the first display device to the N^{th} display device.

According to an example embodiment of the disclosure, the command for requesting the state data may include ID information of each display device and information about a type of the state data to be collected. The state data may include at least one of temperature information, humidity information, or coordinate information.

According to an example embodiment of the disclosure, the control data may include the ID information of each display device and control information instructing the display device to perform operations. The control information may include at least one of coordinate setting information, brightness setting information, or resolution setting information.

According to an example embodiment of the disclosure, there is provided a display device 201. The display device 201 according to an embodiment of the disclosure may include at least one processor 220 including processing circuitry. The display device 201 according to an embodiment of the disclosure may include a memory 230 storing one or more instructions. The one or more instructions, when executed by the at least one processor 220 individually or collectively, may cause the display device 201 to receive, through a communicator 210, an image frame including image data, a command for requesting state data for each of a plurality of display devices included in a multi-display, and a data space for writing the state data for each of the plurality of display devices. The one or more instructions, when executed by the at least one processor 220 individually or collectively, may cause the display device 201 to write, on the image frame, the state data of the display device.

The display device 201 may transmit, through the communicator 210, the image frame including the state data.

The display device 201 may transmit, based on address information included in the image frame, the image frame including the state data of the display device 201, to another display device arranged to be adjacent to the display device 201.

The display device 201 may transmit, based on address information included in the image frame, the image frame including the state data to the electronic device 100 requesting the image frame.

The display device 201 may receive an image frame including the image data and control data for each of the plurality of display devices.

The one or more instructions, when executed by the at least one processor 220 individually or collectively, may cause the display device 201 to perform an operation based on control data corresponding to the display device from the control data for each of the plurality of display devices.

According to an example embodiment of the disclosure, there is provided a method of operating the electronic device 100. According to an embodiment of the disclosure, the operating method of the electronic device 100 may include generating an image frame including image data, a command for requesting state data for each of a plurality of display devices included in a multi-display, and a data space for writing the state data for each of the plurality of display devices.

The method of operating the electronic device 100 may include transmitting the image frame to the multi-display.

The method of operating the electronic device 100 may include receiving, from the multi-display, the image frame including the state data obtained from each of the plurality of display devices while the image frame is being transmitted from a first display device to an N^{th} display device which are included in the plurality of display devices.

The receiving of the image frame from the multi-display may include receiving the image frame in a direction inverse to a sequential transmission direction from the first display device to the N^{th} display device.

The method of operating the electronic device 100 may further include generating, based on the state data for each of the plurality of display devices, the state data being included in the image frame, control data for each of the plurality of display devices. The operating method of the electronic device 100 may further include generating the image frame including the image data and the control data for each of the plurality of display devices and transmitting the image frame to the multi-display.

According to an example embodiment of the disclosure, there is provided a method of operating the display device 201. The method of operating the display device 201, according to an embodiment of the disclosure, may include receiving an image frame including image data, a command for requesting state data for each of a plurality of display devices included in a multi-display, and a data space for writing the state data for each of the plurality of display devices.

The method of operating the display device 201 may include writing, on the image frame, the state data of the display device. The operating method of the display device 201 may include transmitting the image frame including the state data of the display device 201.

The transmitting of the image frame may include transmitting, based on address information included in the image frame, the image frame including the state data of the display device, to another display device arranged to be adjacent to the display device.

The transmitting of the image frame may include transmitting, based on address information included in the image frame, the image frame including the state data to the electronic device 100 requesting the image frame.

The receiving of the image frame may include receiving an image frame including the image data and control data for each of the plurality of display devices.

The method of operating the display device 201 may further include performing an operation based on control data corresponding to the display device 201 from the control data for each of the plurality of display devices.

According to an example of the disclosure, there is provided a non-transitory computer-readable recording medium having recorded thereon a program for executing, on a computer, the operating method of the electronic device.

According to an example embodiment of the disclosure, there is provided a non-transitory computer-readable recording medium having recorded thereon a program for executing, on a computer, the operating method of the display device.

According to an embodiment of the disclosure, in a multi-display system, by transmitting and receiving one image frame, state data for each of a plurality of display devices may be requested and collected, and thus, a diagnosis speed based on the state data for all of the plurality of display devices may be improved, and the diagnosis time may be reduced.

According to an embodiment of the disclosure, in the multi-display system, by transmitting control data for each of the plurality of display devices using one image frame, a control speed with respect to all of the plurality of display devices may be improved, and the control time may be reduced.

The disclosure described above may be written as a program executable by a computer and may be realized by a general-purpose digital computer for operating the program using a computer-readable medium. The structures of the data used in the disclosure described above may be recorded on a computer-readable medium through various means. The disclosure may be realized as a recording medium including a computer-executable instruction, such as a program module executed by a computer. For example, methods realized as software modules or algorithms may be stored on a computer-readable recording medium as the codes or program commands which may be read and executed by a computer.

The computer-readable medium may be an arbitrary recording medium accessible by a computer and may include a volatile or non-volatile medium and a detachable or non-detachable medium. The computer-readable medium may include a magnetic storage medium, for example, ROM, floppy disk, hard disk, etc., or an optical-readable medium, for example, CD-ROM, DVD, etc., but is not limited thereto. Also, the computer-readable medium may include a computer storage medium and a communication medium.

A plurality of computer-readable recording media may be distributed in computer systems connected through a network, and data, for example, program instructions and codes, stored in the distributed recording media may be executed by at least one computer.

A machine-readable storage medium may be provided in the form of a non-transitory storage medium. Here, the “non-transitory storage medium” may refer to a medium that is a tangible device and may not include signals (e.g., electromagnetic waves), and the term does not distinguish a storage medium semi-permanently storing data and a storage medium temporarily storing data. For example, the “non-transitory storage medium” may include a buffer temporarily storing data.

According to an embodiment, the method according to various embodiments according to the disclosure may be provided as an inclusion of a computer program product. The computer program product may be transacted between a seller and a purchaser as a product. The computer program product may be distributed in the form of a machine-readable storage medium (e.g., compact disc read only memory (CD-ROM)) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

Example executions in the disclosure are described according to various example embodiments of the disclosure and do not limit the scope of the disclosure. For the brevity of the disclosure, descriptions of electronic components, control systems, software, and other functional aspects of the systems according to the related art may be omitted.

The description of the disclosure above is for an example, and it would be understood by one of ordinary skill in the art that the disclosure may be easily modified as other detailed forms without changing the technical concept or essential characteristics of the disclosure. Therefore, it will be understood that the various embodiments described above are examples in all aspects and are not limiting of the scope of the disclosure. For example, each of components described as single units may be executed in a distributed fashion, and likewise, each of components described in a distributed fashion may be executed in a combined fashion.

In this disclosure, the use of all examples or example terms, for example, the use of “etc.,” is merely to describe the disclosure in detail, and unless defined so by the scope of the claims, the scope of the disclosure is not limited by these examples or example terms.

Unless specifically described as “essential” or “important,” the components described in the disclosure may not be essential components for executing the disclosure.

One of ordinary skill in the art related to the disclosure may understand that modified forms may be realized within the scope not deviating from essential features in the description.

The disclosure may be variously changed and may have various embodiments of the disclosure. Thus, the disclosure is not limited to a particular execution form described in the disclosure, and it shall be understood that all changes, equivalents, or substitutes included in the concept and the technical scope of the disclosure are included in the disclosure. Therefore, the various embodiments of the disclosure should be understood from a descriptive perspective rather than a limiting perspective.

The scope of the disclosure is not limited by the detailed description of the disclosure above, and it shall be understood that all modified and changed forms derived from the meanings and scopes of the claims and their equivalent concepts are included in the range of the disclosure.
Terms such as “unit,” “module,” etc., described in the disclosure indicate a unit that processes at least one function or operation, and the unit may be embodied in a hardware manner, a software manner, or a combination of the hardware manner and the software manner.

The “unit” and “module” may be stored in a storage medium which may be addressed, or may be realized by a program executable by a processor.

For example, a “portion” and a “module” may be realized by components, such as software components, object-oriented software components, class components, and task components, processes, functions, attributes, procedures, sub-routines, segments of a program code, drivers, firmware, a microcode, a circuit, data, a database, data structures, tables, arrays, and variables.

In this disclosure, the description that “A may include one of a1, a2, and a3” denotes a broad meaning that example elements included in the element A may include a1, a2, or a3.

The disclosure may not denote that the elements which may be included in the element A are necessarily limited to a1, a2, or a3. Thus, it shall be noted that the elements which may be included in the element A are not exclusively interpreted as excluding other elements not described except for a1, a2, and a3.

The disclosure may denote that the element A may include a1, a2, or a3. The disclosure may not denote that the elements which may be included in the element A are necessarily and selectively determined from a predetermined set. For example, it shall be noted that the description is not interpreted in a limiting sense as the element A including a1, a2, or a3 necessarily selected from a set including a1, a2, and 3.

What is claimed is:

1. An electronic device comprising:
a communicator comprising communication circuitry;
at least one processor comprising processing circuitry; and
memory storing one or more instructions,
wherein at least one processor, individually and/or collectively, is configured to execute the instructions and to cause the electronic device to:
generate an image frame comprising image data, a command for requesting state data for each of a plurality of display devices included in a multi-display, and a data space for writing the state data for each of the plurality of display devices;
control the communicator to transmit the image frame to the multi-display; and
control the communicator to receive, from the multi-display, the image frame comprising the state data obtained from each of the plurality of display devices while the image frame is being transmitted from a first display device to an N^{th} display device which are included in the plurality of display devices.

2. The electronic device of claim 1, wherein at least one processor, individually and/or collectively, is configured to cause the electronic device to:
generate, based on the state data for each of the plurality of display devices, the state data being included in the image frame, control data for each of the plurality of display devices; and
generate the image frame comprising the image data and the control data for each of the plurality of display devices and transmit the image frame to the multi-display.

3. The electronic device of claim 1, wherein at least one processor, individually and/or collectively, is configured to cause the electronic device to control the communicator to receive the image frame in a direction inverse to a sequential transmission direction from the first display device to the N^{th} display device.

4. The electronic device of claim 1, wherein the command for requesting the state data comprises identification (ID) information of each display device and information about a type of the state data to be collected, and
the state data comprises at least one of temperature information, humidity information, or coordinate information.

5. The electronic device of claim 4, wherein the control data comprises the ID information of each display device and control information instructing the display device to perform operations, and
the control information comprises at least one of coordinate setting information, brightness setting information, or resolution setting information.

6. A display device comprising:
a communicator comprising communication circuitry;
at least one processor comprising processing circuitry; and
memory storing one or more instructions,
wherein at least one processor, individually and/or collectively, is configured to cause the display device to:
receive, through the communicator, an image frame comprising image data, a command for requesting state data for each of a plurality of display devices included in a multi-display, and a data space for writing the state data for each of the plurality of display devices;
write, on the image frame, the state data of the display device; and
transmit, through the communicator, the image frame comprising the state data.

7. The display device of claim 6, wherein at least one processor, individually and/or collectively, is configured to cause the display device to:
receive an image frame comprising the image data and control data for each of the plurality of display devices; and
perform an operation based on control data corresponding to the display device from the control data for each of the plurality of display devices.

8. The display device of claim 6, wherein at least one processor, individually and/or collectively, is configured to cause the display device to transmit, based on address information included in the image frame, the image frame comprising the state data of the display device, to another display device arranged to be adjacent to the display device.

9. The display device of claim 6, wherein at least one processor, individually and/or collectively, is configured to cause the display device to transmit, based on address information included in the image frame, the image frame comprising the state data to an electronic device requesting the image frame.

10. A method of operating an electronic device, the method comprising:
generating an image frame comprising image data, a command for requesting state data for each of a plurality of display devices included in a multi-display, and a data space for writing the state data for each of the plurality of display devices;
transmitting the image frame to the multi-display; and
receiving, from the multi-display, the image frame comprising the state data obtained from each of the plurality of display devices while the image frame is being transmitted from a first display device to an N^{th} display device which are included in the plurality of display devices.

11. The method of claim 10, further comprising generating, based on the state data for each of the plurality of display devices, the state data being included in the image frame, control data for each of the plurality of display devices, and generating the image frame comprising the image data and the control data for each of the plurality of display devices and transmitting the image frame to the multi-display.

12. The method of claim 10, wherein the receiving of the image frame from the multi-display comprises receiving the image frame in a direction inverse to a sequential transmission direction from the first display device to the N^{th} display device.

13. The method of claim 10, wherein the command for requesting the state data comprises identification (ID) information of each display device and information about a type of the state data to be collected, and
the state data comprises at least one of temperature information, humidity information, or coordinate information.

14. The operating method of claim 13, wherein the control data comprises the ID information of the display device and control information instructing the display device to perform operations, and
the control information comprises at least one of coordinate setting information, brightness setting information, or resolution setting information.
